(19) United States
(12) Patent Application Publication
(10) Pub. No.: US 2009/0247261 A1
(43) Pub. Date: Oct. 1, 2009

(54) Slot Machine

(75) Inventor: Ikuro KOAMI, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/206,303

(22) Filed: Sep. 8, 2008

Related U.S. Application Data
(60) Provisional application No. 61/041,343, filed on Apr. 1, 2008.

(51) Int. Cl. A63F 9/24; A63F 13/00

(52) U.S. Cl. 463/20

(57) ABSTRACT

A slot machine according to the present invention includes: a display device having a symbol display region for displaying a plural types of symbols; a casing; a side wall making up part of the casing, formed with an opening in a predetermined shape; a light emitting device provided inside the casing, at a position corresponding to the opening formed in the side wall; a memory for storing a plurality of light emission patterns of the light emitting device; and a controller for controlling the display device, the light emitting device, and the memory. The controller rearranges the plural types of symbols in the symbol display region during the basic game; award a payout in accordance with a predetermined combination, in the case where symbols displayed on the symbol display region are arranged in the predetermined combination; and reads the light emission patterns stored in the memory, and control the light emitting device to emit light in accordance with the read light emission pattern.

### CROSS-REFERENCE TO RELATED APPLICATIONS

This application claims priority of U.S. Provisional Application No. 61/041,343 filed on Apr. 1, 2008. The contents of this application are incorporated herein by reference in their entirety.

### BACKGROUND OF THE INVENTION

1. Field of the Invention

The present invention relates to a slot machine.

2. Description of the Related Art

In a conventional slot machine, when a player inserts a game medium, such as a coin and a bill, in an insertion slot of a slot machine and presses a SPIN button, a display provided on a front face of a cabinet displays a plurality of symbols in a scrolling manner. Then, scrolling of each of the symbols is automatically stopped.

As such a slot machine, for example, as disclosed in U.S. Pat. No. 6,093,102, a slot machine exists which employs a concept of a winning line. In this concept, in case a combination of symbols rearranged on a winning line is a predetermined winning combination, a predetermined number of game media are paid out.

In addition, as such a slot machine, for example, as disclosed in each of U.S. Pat. No. 6,604,999 and U.S. Patent Publication No. 2002/0065124, a slot machine exists which provides two types of payouts, including a payout determined by a combination of symbols rearranged on a winning line and a payout determined by a number of displayed scatter symbols.

In the conventional slot machines, however, players are allowed to have only the feeling of expectation for a random payout based on a combination of plural types of symbols randomly arranged in the display device. Therefore, as players continue playing the game for a long time, they sometimes get bored with the slot game due to its repetitive monotonous effect display. Further, while the conventional slot machine has a melamine facing plate attached to a casing, only high cost has resulted, no change has occurred, and there has been less consideration for entertainability.

The present invention has been made in view of the above-described circumstance. It is an object of the invention to provide a novel slot machine which can offer entertainability to players that has not been successfully attained by those of the aforementioned conventional art.

### SUMMARY OF THE INVENTION

A first aspect of the present invention is a slot machine including: a display device having a symbol display region for displaying plural types of symbols; a casing; a side wall making up part of the casing, formed with an opening in a predetermined shape; a light emitting device provided inside the casing, at a position corresponding to the opening formed in the side wall; a memory for storing a plurality of light emission patterns of the light emitting device; and a controller for controlling the display device, the light emitting device, and the memory. The controller is programmed to: (a) execute a basic game; (b) rearrange the plural types of symbols in the symbol display region during the basic game; (c) award a payout in accordance with a predetermined combination, in the case where the symbols displayed on the symbol display region are arranged in the predetermined combination; and (d) read one of the light emission patterns stored in the memory to control the light emitting device to emit light in accordance with the read light emission pattern.

According to the first aspect, the slot machine can allow an opening portion to emit light, the opening portion being formed in a side wall of the casing of the slot machine. Thus, for example, part of a melamine facing plate attached to the side wall of the casing is hollowed out and a LED lamp is caused to emit light from the inside so as to make an effect to achieve light emission corresponding to a game status established at the time of a free game or a jackpot bonus game. Therefore, a novel slot machine can be provided which allows players to enjoy new entertainability in addition to conventional one.

A second aspect of the present invention is a slot machine constituted as set forth below. In the first aspect, the controller, in the itemized (d), randomly or selectively executes a first process and a second process, the first process is for controlling the light emitting device to emit light in accordance with the light emission pattern read out of the memory, and the second process is for controlling the light emitting device to emit light regardless of the light emission pattern read out of the memory.

According to the second aspect, the slot machine can allow the opening portion to emit light correspondingly to the symbol combination, the opening portion being formed in a side wall of the casing of the slot machine. Thus, for example, part of a melamine facing plate attached to the side wall of the casing is hollowed out and a LED lamp is caused to emit light from the inside so as to make an effect to achieve light emission corresponding to a combination of symbols, in the case where the combination of symbols is allowed to award any of payouts. Therefore, a novel slot machine can be provided which allows players to enjoy new entertainability in addition to conventional one.

A third aspect of the present invention is a slot machine constituted as set forth below. In the second aspect, the controller, in the itemized (d), randomly or selectively executes a first process and a second process, the first process is for controlling the light emitting device to emit light in accordance with the light emission pattern read out of the memory, and the second process is for controlling the light emitting device to emit light regardless of the light emission pattern read out of the memory.

According to the third aspect, the slot machine can randomly or selectively determine light emission patterns with which the opening portion formed in the side wall of the casing is caused to emit light to make an effect. Therefore, a novel slot machine can be provided which allows players to enjoy new entertainability in addition to conventional one.

A fourth aspect of the present invention is a slot machine including: a display device having a symbol display region for displaying a plural types of symbols; a casing; a side wall making up part of the casing, formed with an opening in a predetermined shape; a light emitting device provided inside the casing, at a position corresponding to the opening formed in the side wall; a memory for storing a plurality of light emission patterns of the light emitting device, in a manner to correspond to combinations of the plural types of symbols rearranged in the symbol display region; and a controller for controlling the display device, the light emitting device, and the memory. The controller is programmed to: (a) execute a basic game; (b) rearrange the plural types of symbols in the symbol display region during the basic game; (c) award a payout in accordance with a predetermined combination, in the case where the symbols displayed on the symbol display region are arranged in the predetermined combination; and (d) read out of the memory, one of the light emission patterns which is corresponding to a combination of the plural types of symbols rearranged in the symbol display region, and controls the light emitting device to emit light in accordance with the light emission pattern read out of the memory.

According to the fourth aspect, the slot machine can allow the opening portion to emit light correspondingly to the symbol combination, the opening portion being formed in a side wall of the casing of the slot machine. Thus, for example, part of a melamine facing plate attached to the side wall of the casing is hollowed out and a LED lamp is caused to emit light from an interior so as to make an effect to achieve light emission corresponding to a combination of symbols, in the case where the combination of symbols is allowed to award any of payouts. Therefore, a novel slot machine can be provided which allows players to enjoy new entertainability in addition to conventional one.

A fifth aspect of the present invention is a slot machine constituted as set forth below. In the fourth aspect, the controller, in the itemized (d), randomly or selectively executes a first process and a second process, the first process is for controlling the light emitting device to emit light in accordance with the light emission pattern read out of the memory, and the second process is for controlling the light emitting device to emit light regardless of the light emission pattern read out of the memory.

According to the fifth aspect, correspondingly to a combination of symbols, the slot machine can randomly or selectively determine light emission patterns with which the opening portion formed in the side wall of the casing is made to emit light to make an effect. Therefore, a novel slot machine can be provided which allows players to enjoy new entertainability in addition to conventional one.

A sixth aspect of the present invention is a slot machine including: a display device having a symbol display region for displaying a plural types of symbols; a casing; a side wall making up part of the casing, formed with an opening in a predetermined shape; a light emitting device provided inside the casing, at a position corresponding to the opening formed in the side wall; a memory for storing a plurality of light emission patterns of the light emitting device, in a manner to correspond to combinations of the plural types of symbols rearranged in the symbol display region; and a controller for controlling the display device, the light emitting device, and the memory. The controller is programmed to: (a) execute a basic game; (b) rearrange the plural types of symbols in the symbol display region during the basic game; (c) award a payout in accordance with a predetermined combination, in the case where the symbols displayed on the symbol display region are arranged in the predetermined combination; and (d) read out of the memory, one of the light emission patterns which is corresponding to a combination of the plural types of symbols rearranged in the symbol display region, and randomly or selectively execute a first process and a second process, the first process is for controlling the light emitting device to emit light in accordance with the light emission pattern read out of the memory, and the second process is for controlling the light emitting device to emit light regardless of the light emission pattern read out of the memory.

According to the sixth aspect, the slot machine can randomly or selectively determine light emission patterns with which the opening portion formed in the side wall of the casing is caused to emit light to make an effect. Therefore, a novel slot machine can be provided which allows players to enjoy new entertainability in addition to conventional one.

### BRIEF DESCRIPTION OF THE DRAWINGS

FIG. 1 is a perspective view schematically showing a slot machine and melamine facing plates according to a first embodiment;

FIG. 2 is a perspective view schematically showing the slot machine according to the first embodiment;

FIG. 3 is a view showing an internal configuration of the slot machine shown in FIG. 2;

FIG. 4 is a view showing one example of a light emission pattern data table according to the first embodiment;

FIG. 5A is a view showing an exemplary image displayed in the slot machine shown in FIG. 2, during a basic game;

FIG. 5B is a view showing an exemplary image displayed in the slot machine shown in FIG. 2, during the basic game;

FIG. 6A is a view showing an exemplary image displayed in the slot machine shown in FIG. 2, during a free game;

FIG. 6B is a view showing an exemplary image displayed in the slot machine shown in FIG. 2, during the free game;

FIG. 7A is a view showing an exemplary image displayed in the slot machine shown in FIG. 2, during a bonus game;

FIG. 7B is a view showing an exemplary image displayed in the slot machine shown in FIG. 2, during the bonus game;

FIG. 8A is a view showing an exemplary image displayed in the slot machine shown in FIG. 2, during the bonus game;

FIG. 8B is a view showing an exemplary image displayed the slot machine shown in FIG. 2, during the bonus game;

FIG. 9A is a view showing an exemplary image displayed in the slot machine shown in FIG. 2, during the bonus game;

FIG. 9B is a view showing an exemplary image displayed in the slot machine shown in FIG. 2, during the bonus game;

FIG. 10 is a flowchart showing a subroutine of a main process;

FIG. 11 is a flowchart showing a subroutine of a game execution process according to the first embodiment;

FIG. 12 is a flowchart showing a subroutine of a free game execution process according to the first embodiment;

FIG. 13 is a flowchart showing a subroutine of a jackpot bonus game execution process according to the first embodiment; and

FIG. 14 is a view schematically showing a frame format of an appearance of a slot machine according to a second embodiment;

### DESCRIPTION OF THE PREFERRED EMBODIMENTS

First, a slot machine 10 according to a first embodiment will be described in detail with reference to the drawings. The slot machine according to the first embodiment is a so-called video slot machine, which has an image display panel such as a liquid crystal display and executes a game by displaying images of various symbols on the image display panel.

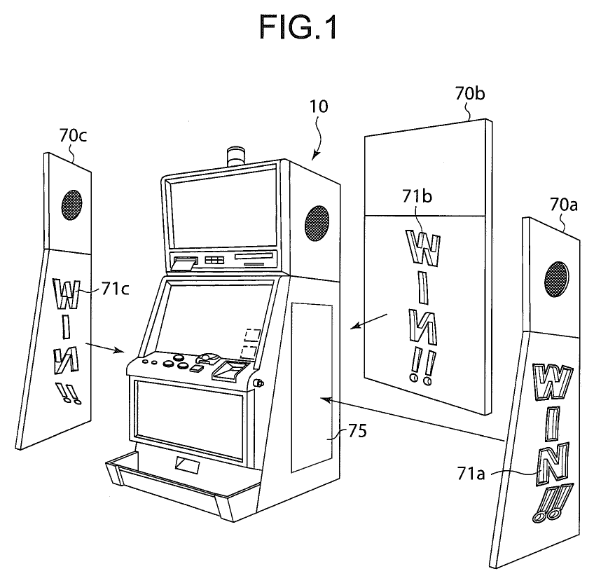

FIG. 1 is a perspective view schematically showing melamine facing plates of the slot machine according to the first embodiment. At side walls of the slot machine 10 according to the present invention, there are provided: melamine facing plates 70a to 70c, each of which is formed with an opening in a predetermined shape; and light emitting devices 75 formed at positions corresponding to the openings. The slot machine 10 executes any one of three types of gaming modes including a basic game, a free game, and a progressive bonus game. The basic game is executed upon consuming a gaming value corresponding to the amount bet by a player. The free game is executed without consuming a gaming value. The progressive bonus game is executed when a jackpot value reaches a predetermined progressive value. While the slot machine 10 is of a stand-alone type, which is not connected to a network, the present invention is also applicable to a networked slot machine.

On a lower image display panel 16 included in the slot machine 10, a symbol matrix SM is displayed. A total of fifteen symbols in three rows and five columns are rearranged in the symbol matrix SM. Any combination of symbols “main character” 121, “sub character” 122, “office building” 123, “gold bullion” 124, “car” 125, “stock certificate” 126, “jet ” 127, and “villa” 128, is rearranged in the symbol matrix SM, and a payout is awarded based on the combination of the rearranged symbols.

As shown in FIG. 1, at the side walls of the slot machines 10, the melamine facing plates 70a to 70c are provided, each of which is formed with the opening in a predetermined shape. Furthermore, in the slot machine 10, the light emitting devices 75 are provided at positions corresponding to the openings formed in the side walls, respectively. In this case, openings 71a to 71c, each of which is formed in a letter shape of “WIN”, are formed in the melamine facing plates 70a to 70c. In the case where the symbols rearranged in the symbol matrix SM form a predetermined combination, the light emitting devices 75 are controlled to emit light in accordance with a light emission pattern at the time of execution of the free game or the jackpot bonus game, and thus, the openings 71a to 71c emit light, each of which is formed in the letter shape “WIN”.

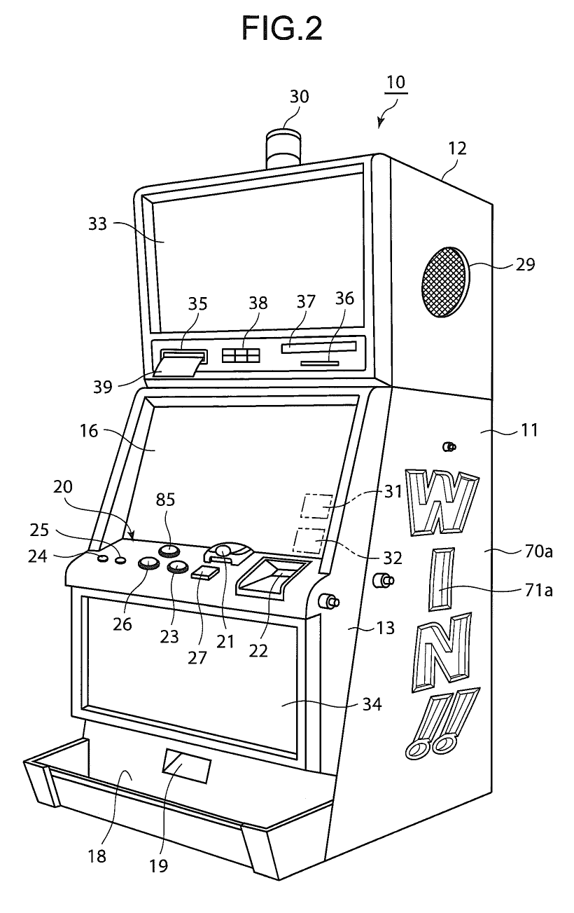

FIG. 2 is a view schematically showing a frame format of an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electronic money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11. On an upper surface of the cabinet 11, the melamine facing plate 70a is provided, in which the opening 71a in the letter shape “WIN” is formed.

The lower image display panel 16 serving as a display device is provided in front of the main door 13. The lower image display panel 16 is provided with a liquid crystal panel, which displays fifteen elements of the symbol matrix 28 in three rows and five columns. In each symbol matrix SM, one symbol is arranged.

A credit amount display unit 31 of the lower image display panel 16 displays the number of coins credited by way of an image. A payout amount display unit 32 displays by way of an image the number of, for example, coins to be paid if a predetermined number or more symbols of respective types are rearranged in the symbol matrix SM.

Provided on a lower side of the lower image display panel 16 are a control panel 20 having a plurality of buttons 23 to 27 and 85 through which a command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, a MAX-BET button 27, and a side-BET button 85 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (50 in this embodiment) of coins that can be bet per game among the credited coins on the game. The side-BET button 85 is intended for entering a command for betting coins during the game when players desire to place a bet on one more game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display 37, and a key pad 38 are provided. The ticket printer 35 prints on a ticket a barcode having encoded thereon data such as the credit amount, data and time, and the identification number of the slot machine 10. Further, this printer outputs the printed ticket as a barcode-attached ticket 39. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 reads data from and write data into a smart card. The smart card is to be owned by the player, which stores data for identifying the player or data regarding the log of games executed by the player, for example. The smart card may store data corresponding to coins, bills, or a credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

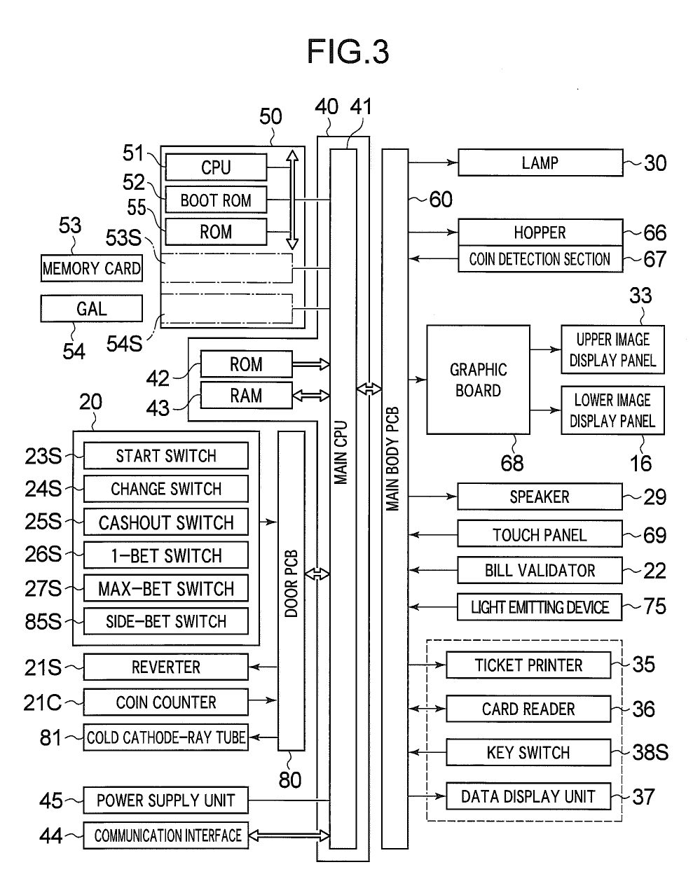

FIG. 3 is a block diagram depicting the internal construction of the slot machine shown in FIG. 2. A gaming board 50 includes: a CPU (Central Processing Unit) 51, a ROM (Read-only Memory) 55 and a boot ROM 52 interconnected by an internal bus; a card slot 53S corresponding to a memory card 53; and an IC socket 54S corresponding to a GAL (Generic Array Logic) 54.

A memory card 53 is composed of a non-volatile memory, such as CompactFlash (registered trademark), and stores a game program. The game programs include a symbol selection program. The aforementioned symbol selection program is intended for determining the symbols to be rearranged in the symbol matrix SM. The symbol selection program includes symbol weighing data corresponding to each of plural types of payout ratios (for example, 80%, 84%, and 88%). The symbol weighting data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the symbol matrix SM are determined depending upon the symbol weighing data corresponding to this payout ratio. Further, the game programs include table data indicating the correspondence relationship between each of the symbols and a payout.

Also, the card slot 53S is configured to allow the memory card 53 to be inserted thereinto or ejected therefrom, and is connected to a mother board 40 through an IDE bus. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. Furthermore, the game program includes image data or sound data to be output during the game. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Also, the IC slot 54S is configured to allow the GAL 54 to be inserted thereinto or ejected therefrom, and is connected to a motherboard 40 through PCI bus. Accordingly, the GAL can be replaced with the replacement GAL 54 to change the payout-ratio setting data.

The CPU 51, the ROM 55, and the boot ROM 52 interconnected by the internal bus are connected to the motherboard 40 by the PCI bus. The PCI bus serves to transmit signals between the mother board 40 and the gaming board 50 and supply power from the mother board 40 to the gaming board 50.

The motherboard 40 is constructed using a general-purpose motherboard commercially available (a printed circuit board on which essential parts of a personal computer are mounted) and includes: a main CPU 41, a ROM (Read Only Memory) 42; a RAM (Random Access Memory) 43; and a communication interface 44. The main CPU 41 functions as a processor for controlling a display device and memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the motherboard 40 by USB. A power supply unit 45 is also connected to the motherboard 40.

Equipment and devices, which generate input signals to be input to the main CPU 41, and equipment and devices, operations of which are controlled by a control signal output from the main CPU41, are connected to the body PCB 60 and the door PCB 80. The main CPU41 executes the game programs stored in RAM 43, based upon an input signal that was input to the main CPU 41, thereby performing predetermined computational processing. Then, this CPU 41 stores results thereof into RAM 43; and transmits control signals to equipment and devices as control processing relative to the equipment and devices.

Connected to the main body PCB 60 are light emitting devices 65, a lamp 30, a hopper 66, a coin detection section 67, a graphic board 68, a speaker 29, a touch panel 69, a bill validator 22, a ticket printer 35, a card reader 36, a key switch 38S, and a data display 37. The lamp 30 is lit up in a predetermined pattern, based upon a control signal output from the main CPU41.

Based on a control signal output from the main CPU 41, each of the light emitting devices 75 emits light in either of two cases, which are randomly or selectively determined, i.e., one in accordance with a light emission pattern read out of the ROM 42, and the other regardless of this read-out light emission pattern.

The hopper 66 is installed in the cabinet 11. This hopper pays out a predetermined number of coins from a coin payout exit 19 to a coin tray 18, based upon a control signal output from the main CPU41. A coin detection section 67 is installed inside the coin payout exit 19. This detecting section outputs an input signal to the main CPU41 at the time of detecting that a predetermined number of coins have been paid out from the coin payout exit 19.

The graphic board 68 controls images displayed on the upper image display panel 33 and the lower image display panel 16, based on a control signal output from the main CPU41. The credit amount display section 31 (see FIG. 2) on the lower image display panel 16 displays the number of credits stored in the RAM43. Further, the payout amount display section 32 (see FIG. 2) on the lower image display panel 16 displays the number of coins to be paid out. The graphic board 68 is equipped with: a VDP (Video Display Processor), which generates image data based upon a control signal output from the main CPU41; and a video RAM, which temporarily stores image data generated by the VDP or the like. The image data used in generating image data with VDP is contained in the game program read from the memory card 53 and stored in the RAM 43.

The bill validator 22 validates whether or not a bill is legitimate and accepts a legitimate bill into the cabinet 11. The bill validator 22, upon accepting a legitimate bill, outputs an input signal to the main CPU 41 based on the bill amount. The main CPU 41 stores in the RAM 43 the credit amount corresponding to the bill amount transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits, to the main CPU41, the data read from the smart card, and writes the read data onto the smart card, based upon a control signal from the main CPU41. The key switch 38S is provided on the key pad 38, and outputs a predetermined input signal to the main CPU41 when a player operates the key pad 38. The data display 37 displays, based upon a control signal output from the main CPU41, the data read by the card reader 36 and the data input by a player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to the cashout button 25; a 1-BET switch 26S corresponding to the 1-BET button 26; a MAX-BET switch 27S corresponding to the MAX-BET button 27; and a side-BET switch 85S corresponding to the side-BET button 85. When the player operates the buttons 23 to 27 and 85, the corresponding switches 23S to 27S and 85S output input signals to the main CPU 41, respectively.

The coin counter 21C is provided inside the coin receiving slot 21, and validates whether or not a legitimate coin is inserted by a player into the coin receiving slot 21. Those other than the legitimate coins are discharged from the coin payout exit 19. The coin counter 21C also outputs an input signal to the main CPU41 if a valid coin is detected.

The reverter 21S operates based on a control signal output from the main CPU 41 and distributes coins recognized as being legitimate by the coin counter 21C into a cash box (not shown in the drawings) or the hopper 66 which is installed inside the slot machine 10. Specifically, when the hopper 66 is filled with coins, the reverter 21S distributes legitimate coins into the hopper 21S. On the other hand, when the hopper 66 is not filled with coins, legitimate coins are distributed into the hopper 66. A cold cathode tube 81 functions as a backlight installed on rear face side of each of the lower image display panel 16 and the upper image display panel 33, and is lit up based on a control signal output from the main CPU 41.

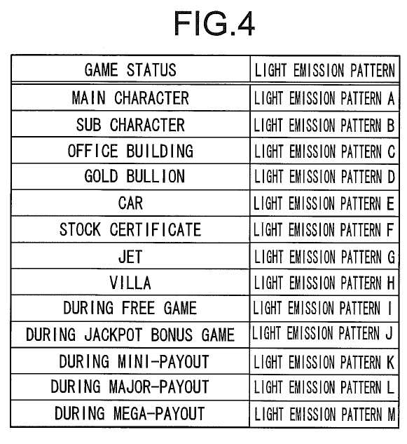

FIG. 4 is a view showing one example of a light emission pattern data table according to the first embodiment. This light emission pattern data table is stored in the ROM 43, and is used to determine a light emission pattern of the light emitting device 75 at the time of execution of the free game or the jackpot bonus game, in the case where the symbols arranged in the symbol matrix SM form a predetermined combination. As shown in FIG. 4, a light emission pattern is determined in accordance, with a game status with use of the light emission pattern data table. For example, a “light emission pattern A” is determined so the light emitting device 75 as to emit light based on the “light emission pattern A”, in the case where the predetermined number of symbols “main character” 121 are rearranged in the symbol matrix SM.

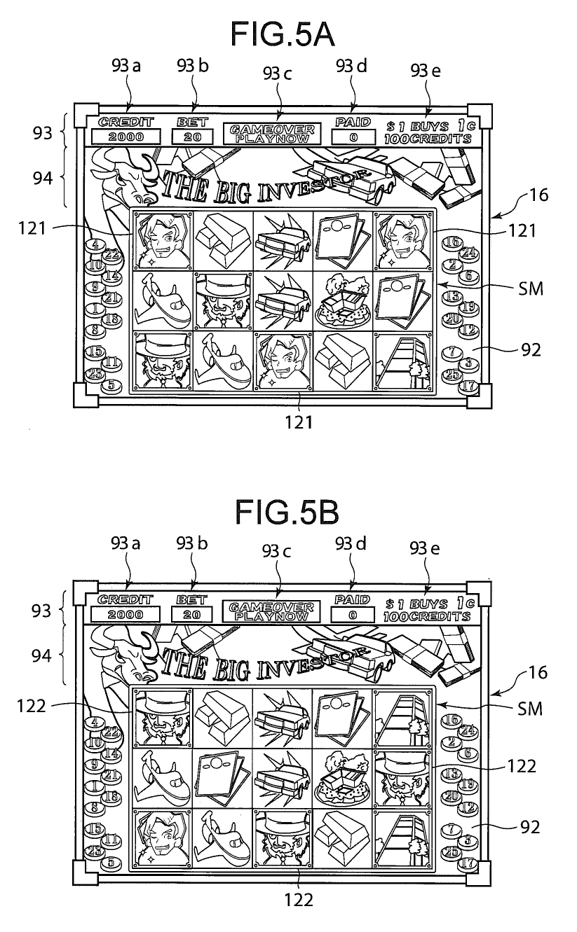

FIGS. 5A and 5B are views each showing an exemplary image displayed in the slot machine according to the first embodiment, shown in FIG. 2. As shown in FIG. 5A, the lower image display panel 16 is made up of a display region 92, an information display section 93, an effect image display section 94, and the like. The display area section 92 is for displaying a symbol matrix SM. In addition, the information display section 93 is arranged above the display area section 92. This display section is made up of a credit amount display section 93a, a BET amount display section 93b, a character information display portion 93c, a PAID amount display section 93d, and a charge display section 93e.

The number of coins presently credited is displayed at the credit amount display section 93a while the number of coins bet in one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that have been successfully obtained in one game is displayed at the PAID amount display section 93d, whereas a conversion value of the credit amount based on a predetermined charge is displayed at the charge display section 93e. At the effect image display section 94, effect images in accordance with a type of the present slot game are displayed.

Any combination of the symbols “main character” 121, “sub character” 122, “office building” 123, “gold bullion” 124, “car” 125, “stock certificate” 126, “jet” 127, and “villa” 128, which are displayed on the lower image display panel 16, is rearranged in the symbol matrix SM displayed on the lower image display panel 16. A payout is determined based on this combination of symbols rearranged in the symbol matrix SM.

Any combination of the symbols “main character” 121, “sub character” 122, “office building” 123, “gold bullion” 124, “car” 125, “stock certificate” 126, “jet” 127, and “villa” 128 is rearranged in the symbol matrix SM. In this case, a combination of three symbols “main character” 121 is rearranged, so that the free game is selected and executed in accordance with this type of the combination. Furthermore, because the aforementioned combination of three symbols “main character” 121 is rearranged, the “light emission pattern A” is read out (see FIG. 4), and the light emitting devices 75 emit light in accordance with this light emission pattern, so that the openings 71a to 71c emit light, each of which is formed in the letter shape “WIN” (see FIG. 2).

As shown in FIG. 5B, any combination of symbols “main character” 121, “sub character” 122, “office building” 123, “gold bullion” 124, “car” 125, “stock certificate” 126, “jet ” 127, and “villa” 128 is rearranged in the symbol matrix SM, and a payout is determined based on the combination of symbols rearranged in the symbol matrix SM.

Any combination of the symbols “main character” 121, “sub character” 122, “office building” 123, “gold bullion” 124, “car” 125, “stock certificate” 126, “jet” 127, and “villa” 128 is rearranged in the elements of the symbol matrix SM. In this case, a combination of three symbols “sub character” 122 is rearranged, so that the jackpot bonus game is selected and executed in accordance with this type of the combination. Furthermore, because the aforementioned combination of three symbols “sub character” 122 is rearranged, a “light emission pattern B” is read out (see FIG. 4), and the light emitting devices 75 emit light in accordance with this light emission pattern, so that the openings 71a to 71c emit light, each of which is formed in the letter shape “WIN” (see FIG. 2).

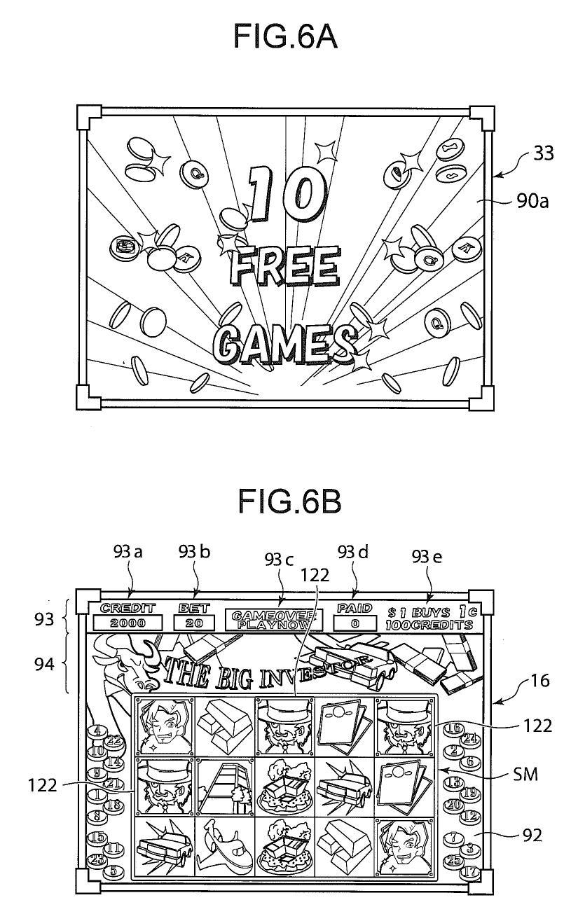

FIGS. 6A and 6B are views each showing an exemplary image displayed during the free game in the slot machine 10 shown in FIG. 2. As shown in FIGS. 6A and 6B, when the symbols rearranged in the symbol matrix SM in FIGS. 5A and 5B form a combination for executing the free game, the free game is started. Upon start of the free game, the upper image display panel 33 displays a free-game-number display image 90a indicative of the number of times in executing the free game. In this case, the free-game-number display image 90a of “10 FREE GAME” is displayed indicating that the number of times in executing the free game has been set to ten. When the free game is started, a “light emission pattern I” is read out of the ROM 42 (see FIG. 4), and the light emitting devices 75 emit light in accordance with the light emission pattern, so that the openings 71a to 71c emit light, each of which is formed in the letter shape “WIN” (see FIG. 2).

As shown in FIG. 6B, any combination of the symbols “main character” 121, “sub character” 122, “office building” 123, “gold bullion” 124, “car” 125, “stock certificate” 126, “jet” 127, and “villa” 128, is rearranged in the symbol matrix SM. In this case, a combination of three symbols “sub character” 122 is rearranged, so that the jackpot bonus game is selected and executed in accordance with this type of the combination. Furthermore, because the aforementioned combination of three symbols “sub character” 122 is rearranged, the “light emission pattern B” is read out (see FIG. 4), and the light emitting devices 75 emit light in accordance with this light emission pattern, so that the openings 71a to 71c emit light, each of which is formed in the letter shape “WIN” (see FIG. 2).

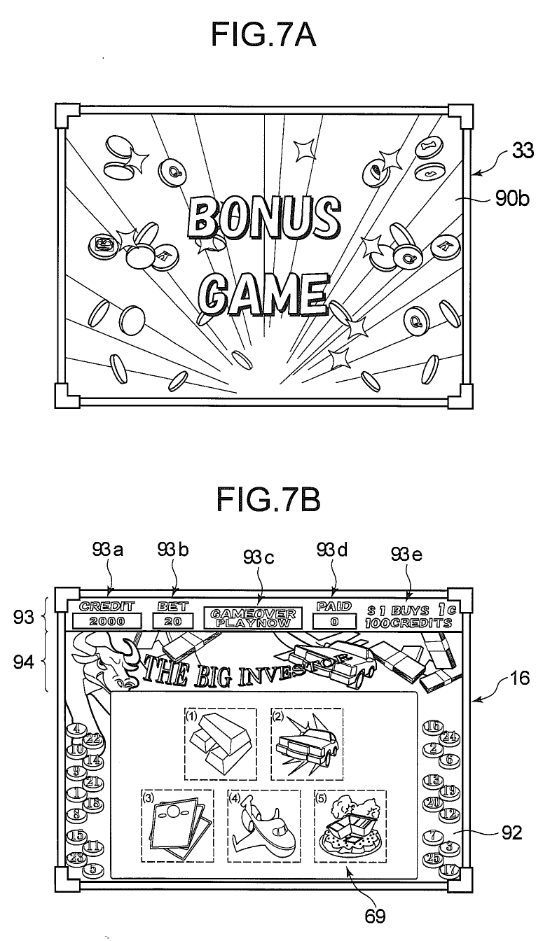

FIG. 7A to FIG. 9B are views each showing an exemplary image displayed during the bonus game in the slot machine 10 shown in FIG. 2. As shown in FIG. 7A, when the symbols rearranged in the symbol matrix SM in FIGS. 5B and 6B form a combination for executing the jackpot bonus game, the jackpot bonus game is started. When start of the jackpot bonus game is determined, the upper image display panel 33 displays a jackpot-bonus-game display image 90b indicative of start of the jackpot bonus game. In this case, the jackpot-bonus-game display image 90b of “BONUS GAME” is displayed indicating that the jackpot bonus game is to be started. Furthermore, when the jackpot game is started, a “light emission pattern J” is read out of the ROM 42 (see FIG. 4), and the light emitting devices 75 emit light in accordance with the light emission pattern, so that the openings 71a to 71c emit light, each of which is formed in the letter shape “WIN” (see FIG. 2).

As shown in FIG. 7B, when the jackpot bonus game is started, the display region 92 displays a selection screen for determining types of jackpot bonus games. In this case, the symbols (1) to (5) including “gold bullion” 124, “car” 125, “stock certificate” 126, “jet” 127, and “villa” 128 are displayed to allow a player to select a type of the jackpot bonus game by selecting one of these symbols though a touch panel 69.

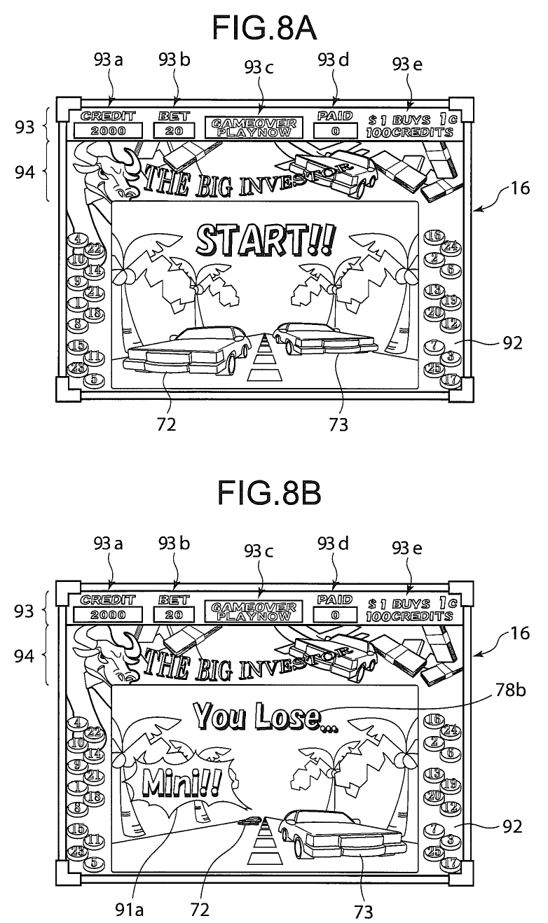

FIGS. 8A and 8B are views each showing an exemplary image displayed during the jackpot bonus game in the slot machine 10 shown in FIG. 2. As shown in FIG. 8A, the jackpot bonus game corresponding to the symbol selected in FIG. 7B is displayed. Because the symbol (2) is selected in FIG. 7B, the jackpot bonus game of a car race is started. A car-race start screen composed of the main character effect image 72 and the sub character effect image 73 is then displayed.

As shown in FIG. 8B, displayed next is a win-or-lose screen of the jackpot bonus game that corresponds to the symbol selected in FIG. 7B. When the symbol (2) is selected in FIG. 7B and the sub character effect image 73 wins in the jackpot bonus game of a car race, a win-or-lose information display 78b of “You Lose” is displayed. A payout display image 91a of “Mini” is displayed which is indicative of a payout type of the jackpot. The payout corresponding to “Mini” is then awarded. When a payout is started, a “light emission pattern K” is read out of the ROM 42 (see FIG. 4), and the light emitting devices 75 emit light in accordance with the light emission pattern, so that the openings 71a to 71c emit light, each of which is formed in the letter shape “WIN” (see FIG. 2).

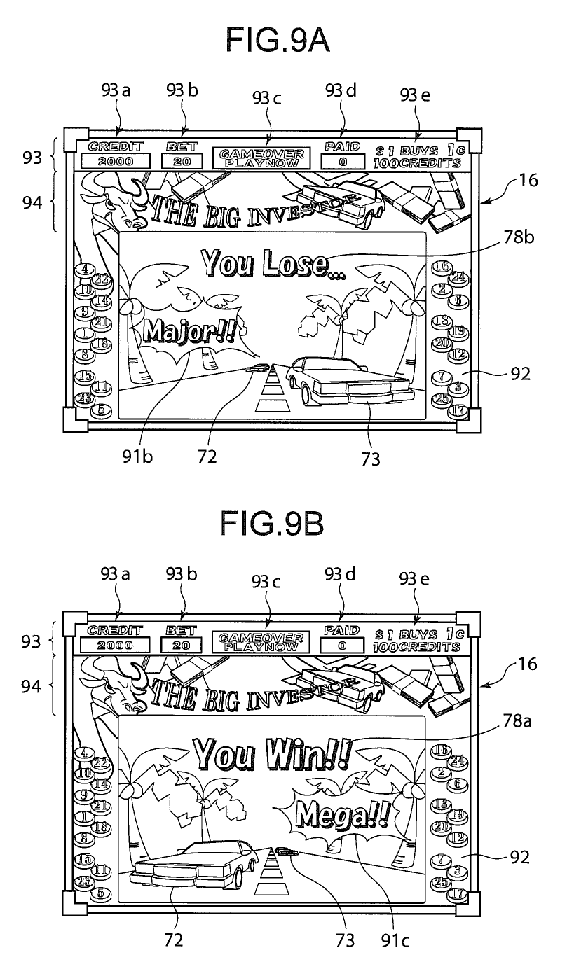

FIGS. 9A and 9B are views each showing an exemplary image displayed during the jackpot bonus game in the slot machine 10 shown in FIG. 2. As shown in FIG. 9A, when the symbol (2) is selected in FIG. 8B and the main character effect image 72 wins in the jackpot bonus game of a car race, a subsequent jackpot bonus game is started. In this case, the jackpot bonus game of the car race is started. In the case where the sub character effect image 73 wins, a win-or-lose information display 78b of “You Lose” is displayed. Further, a payout display image 91b of “Major” indicative of a type of payout of the jackpot is displayed, and a payout corresponding to “Major” is awarded. When a payout is started, a “light emission pattern L” is read out of the ROM 42 (see FIG. 4), and the light emitting devices 75 emit light in accordance with the light emission pattern, so that the openings 71a to 71c emit light, each of which is formed in the letter shape “WIN” (see FIG. 2).

As shown in FIG. 9B, in the case where the symbol (2) is selected in FIG. 8B and a main character effect image 72 wins in the jackpot bonus game of the car race, the next jackpot bonus game is started. In this case, the jackpot bonus game of the car race is started. In the case where the main character effect image 72 wins, a win-or-lose information display 78a of “You Win” is displayed. Further, a payout display image 91c of “Mega” indicative of a type of payouts of the jackpot is displayed, and a payout corresponding to “Mega” is awarded. When a payout is started, a “light emission pattern M” is read out of the ROM 42 (see FIG. 4), and the light emitting devices 75 emit light in accordance with the light emission pattern, so that the openings 71a to 71c emit light, each of which is formed in the letter shape “WIN” (see FIG. 2).

Next, a process executed in the slot machine 10 according to the first embodiment will be described in detail with reference to the accompanying drawings. The main CPU 41 reads out and executes a game program, thereby conducting the game.

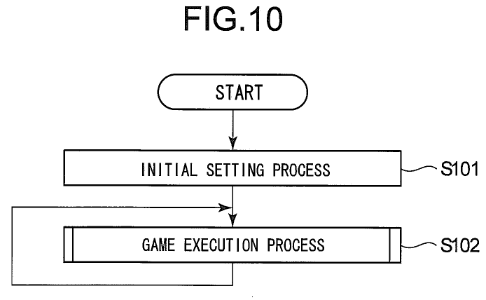

FIG. 10 is a flowchart showing a subroutine of the main process. In the main process, first, when a power switch is turned on (that is, when power is supplied), a motherboard 40 and a gaming board 50 are activated respectively, so that the CPU 41 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. Further, the main CPU 41 writes game programs or the like from the ROM 42 into the RAM 43, and acquires payout-ratio setting data and country-identification information. The main CPU 41 also performs an authentication process for each program during execution of the initial setting process.

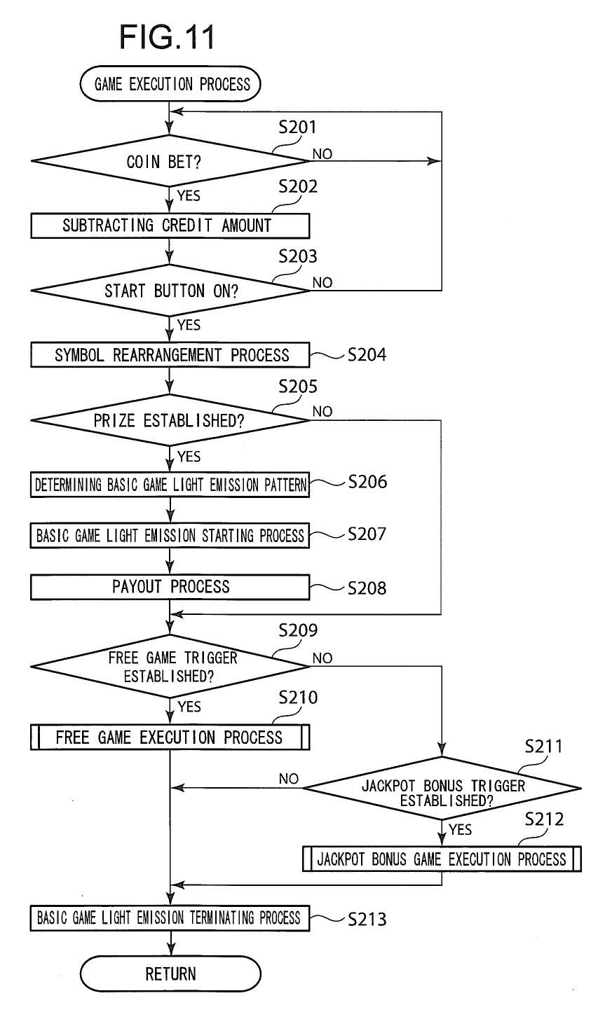

Next, the main CPU 41 performs a game execution process described later with reference to FIG. 11 (step S 102). In this game execution process, the main CPU 41 sequentially reads and executes the game programs or the like from the ROM42. By performing this game execution process, the slot machine 10 executes the game according to the first embodiment. The game execution process is repeatedly performed while power is supplied to the slot machine 10.

FIG. 11 is a flowchart showing a subroutine of the game execution process invoked and performed at step S102 of the subroutine shown in FIG. 10. First, the main CPU 41 judges whether a coin has been bet or not (step S201). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the current step to return to the process at step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). In the case where the number of bet coins is larger than the credit amount stored in the RAM 43, the main CPU 41 controls the current step to return to step S201 without performing the process for subtracting the number of bet coins from the credit amount stored in the RAM 43. In the case where the number of bet coins exceeds the upper limit (fifty coins in this embodiment) of coins that can be bet in one game, the main CPU 41 controls the process to shift to step S203 without performing the process for subtracting the number of bet coins from the credit amount stored in the RAM 43.

At step S203, the main CPU 41 judges whether or not the start button 23 has been set to ON (step S203). Specifically, the main CPU 41 judges whether or not an input signal has been received, the signal being output from the start switch 23S when the start button 23 is pushed. The main CPU 41 controls the step to return to step S201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

On the other hand, the main CPU 41 performs a symbol rearrangement process (step S204) upon judging that the start button 23 has been set to ON (step S203: YES). The main CPU 41 executes the program stored in the RAM 43 and determines the symbols to be rearranged in the symbol matrix SM displayed on the lower image display panel 16. These symbols are selected from among the symbols, “main character” 121, “sub character” 122, “office building” 123, “gold bullion” 124, “car” 125, “stock” certificate 126, “jet” 127, and “villa” 128. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether a prize has been established or not (step S205). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Next, upon judging that the prize has been established (step S205: YES), the main CPU 41 determines a basic game light emission pattern (step S206). Specifically, the main CPU 41 reads and determines a light emission pattern corresponding to a combination of symbols arranged in the symbol matrix SM, from among light emission patterns stored in the ROM 42 (see FIG. 4).

Next, the main CPU 41 executes a basic game light emission starting process (step S207). Specifically, the main CPU 41 starts light emission control of the light emitting device 75 in accordance with the light emission pattern determined at step S206.

The main CPU 41 then executes a coin-payout process in accordance with the amount of bet and the number of coins set for the winning number (step S208). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

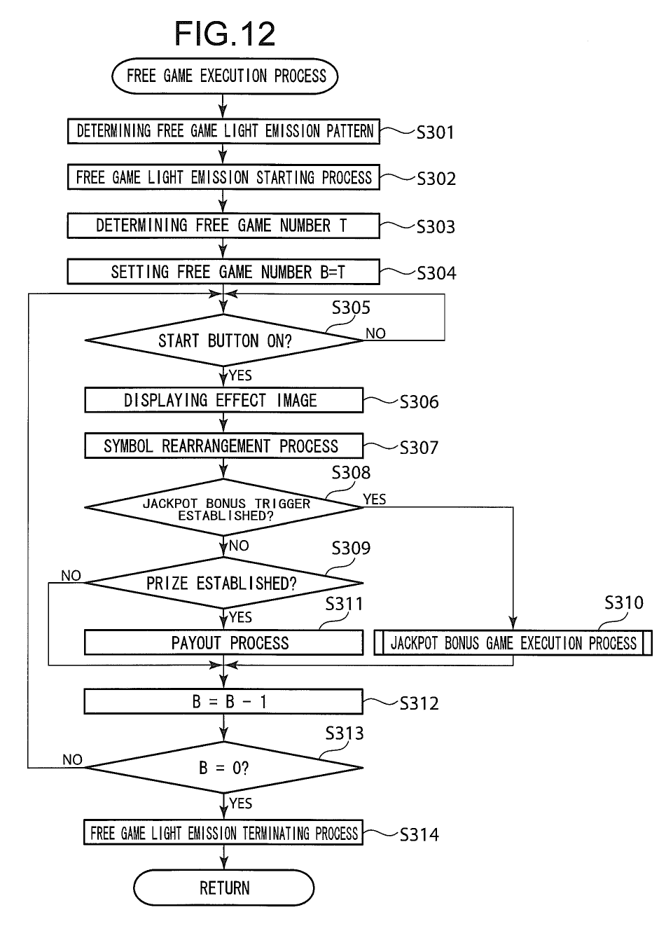

On the other hand, upon judging that the prize has not been established (step S205: NO) or executing the process at step S208, the main CPU 41 judges whether or not a free game trigger has been established (step S209). Specifically, the main CPU 41 executes the program stored in the RAM 43 to sample the random numeric values in a numerical range which comes under a predetermined range of random numeric values, thereby judging whether or not the free game trigger condition has been established based on the sampled random numeric values. Upon judging that the free game trigger has been established (step S209: YES), the main CPU 41 performs a free game execution process described later with reference to FIG. 12 (step S210). In this free-game execution process, the main CPU 41 sequentially reads and executes the game programs or the like from the ROM 42 and performs the free-game execution process.

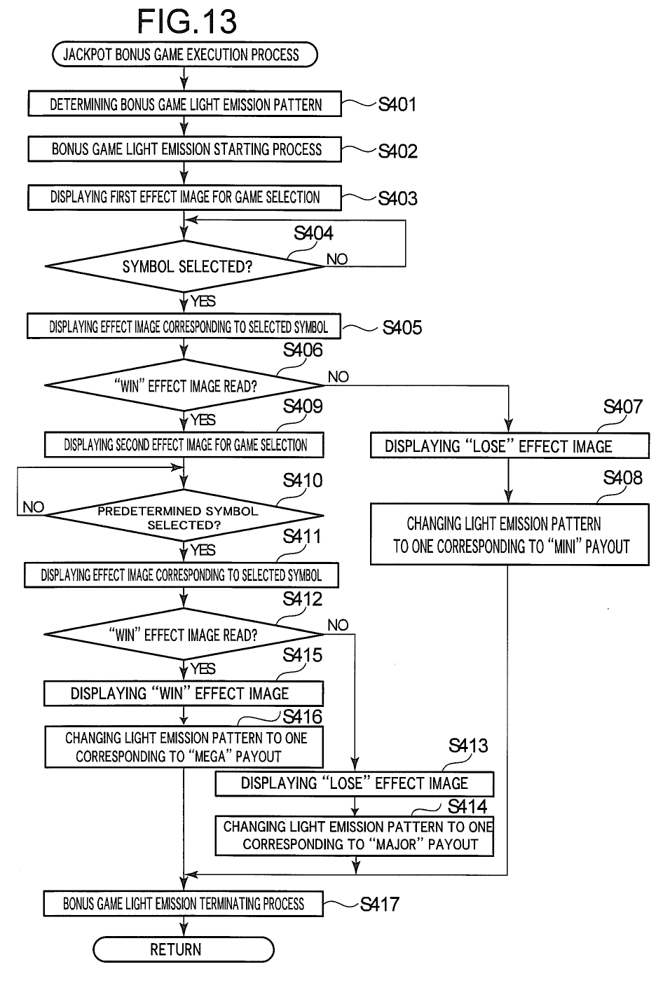

On the other hand, upon judging that the free game trigger has not been established (step S209: NO), the main CPU41 judges whether or not a jackpot bonus game trigger has been established (step S211). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the free game trigger has been established (step S211: YES), the main CPU 41 executes a jackpot bonus game execution process described later with reference to FIG. 13 (step S212). In this jackpot bonus game, the main CPU 41 sequentially reads and executes the game programs or the like from the ROM42 to execute the jackpot bonus game execution process.

The CPU 41 executes a basic game light emission terminating process when judging that the jackpot bonus game trigger has not been established (step S211: NO) or when executing the process at step A210 or S212. Specifically, the main CPU 41 terminates the light emission control of the light emitting device 75 started at step S207. When terminating this process, the main CPU 41 terminates the game execution process.

FIG. 12 is a flowchart showing a subroutine of a free game execution process invoked and executed at step S210 of the subroutine shown in FIG. 11. First, the main CPU 41 determines a free game light emission pattern (step S301). Specifically, the main CPU 41 reads and determines a light emission pattern corresponding to the free game, from among light emission patterns stored in the ROM 42 (see FIG. 4).

Next, the main CPU 41 executes a free game light emission starting process (step S302). Specifically, the main CPU 41 starts the light emission control of the light emitting device 75 in accordance with the light emission pattern determined at step S301.

The main CPU 41 then determines a free-game number T as a number of times in executing the free game (step S303). Specifically, the main CPU 41 determines the free-game number T in accordance with a program stored in the RAM 43.

Next, the main CPU 41 performs a process for setting the free-game number B=T (step S304). Specifically, the main CPU 41 sets a remaining free-game number B=T in the storage area provided in the RAM 43, the area for storing the data indicative of the remaining free-game number B as the remaining number of times in executing the free game. A value of T is equal to the free-game number T determined at step S303.

The main CPU 41 then judges whether or not the start button 23 has been set to ON (step S305). Specifically, the main CPU 41 judges whether or not an input signal has been received, the signal being output from the start switch 23S when the start button 23 is pushed. The main CPU 41 controls the step to return to step S305 upon judging that the start button 23 has not been set to ON (step S305: NO).

Upon judging that the start button 23 has been set to ON (step S305: YES), on the other hand, the main CPU 41 performs a process for displaying an effect image (step S306). Specifically, the main CPU 41 displays a free-game-number display images 90a (see FIG. 6A) corresponding to the free-game number on the upper image display panel 33.

Next, the main CPU 41 executes a symbol rearrangement process (step S307). Specifically, the CPU 41 executes the program stored in the RAM 43 and determines the symbols to be rearranged in the symbol matrix SM displayed on the lower image display panel 16. These symbols are selected from among the symbols, “main character” 121, “sub character” 122, “office building” 123, “gold bullion” 124, “car” 125, “stock certificate” 126, “jet” 127, and “villa” 128. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether or not a jackpot bonus trigger has been established (step S308). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has not been established (step S308: NO), the main CPU 41 controls the process to shift to step S309.

On the other hand, upon judging that the jackpot bonus trigger has been established (step S308: YES), the main CPU 41 executes a jackpot bonus game execution process described later with reference to FIG. 13 (step S310). In this jackpot bonus game, the main CPU 41 sequentially reads and executes the game programs or the like from the ROM42 to execute the jackpot bonus game execution process.

Next, the main CPU 41 judges whether or not a prize has been established (step S309). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Thereafter, upon judging that the prize has been established (step S309: YES), the main CPU 41 performs a coin-payout process for paying out the coins of the number set for the winning number (step S311). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

On the other hand, upon judging that the prize has not been established (step S309: NO) or upon executing the processes at step S310 or S311, the main CPU 41 sets the remaining free-game number B=B−1 (step S312). Specifically, the main CPU 41 sets B=B−1 at a value of the free-game number B stored in the RAM 43.

The main CPU 41 then judges whether or not a value of the remaining free-game number B is equal to zero (step S313). Specifically, the main CPU 41 judges whether or not a value of the remaining game number stored in the RAM43 is equal to zero. Upon judging that the value of the remaining free-game number B is not zero (step S313: NO), the main CPU 41 controls the step to return to step S 305.

On the other hand, upon judging that the value of B is equal to zero (step S313: YES), the main CPU 41 terminates the free game light emission process (step S314). Specifically, the main CPU 41 terminates the light emission control of the light emitting device 75 started at step S302. The main CPU 41 terminates the free game execution process when terminating this process.

FIG. 13 is a flowchart showing a subroutine of the jackpot bonus game execution process invoked and performed at step S212 of the subroutine shown in FIG. 11 and at step S310 of the subroutine shown in FIG. 12. First, the main CPU 41 determines a bonus game light emission pattern (step S401). Specifically, the main CPU 41 reads and determines a light emission pattern corresponding to the bonus game, from among light emission patterns stored in the ROM 42 (see FIG. 4).

Next, the main CPU 41 executes the bonus game light emission starting process (step S402). Specifically, the main CPU 41 starts the light emission control of the light emitting device 75 in accordance with the light emission pattern determined at step S401.

The main CPU 41 then displays a first effect selection image (step S403). Specifically, the main CPU 41 displays a jackpot bonus game display image 90b indicative of start of the jackpot bonus game on the upper image display panel 33 and the selection screen through which a type of the jackpot is determined (see FIG. 7) in the display region 92 (see FIG. 7).

Next, the main CPU 41 judges whether or not the symbol has been selected (step S404). Specifically, the main CPU 41 judges whether or not the symbol displayed on the selection screen for determining the types of jackpot bonus games has been selected via the touch panel or the like. Upon judging that the symbol has not been selected (step S404: NO), the main CPU 41 controls the step to return to step S404.

On the other hand, upon judging that the symbol has been selected (step S404: YES), the main CPU 41 displays the selected effect image (step S405). Specifically, the main CPU 41 sequentially reads out of the ROM 42, the effect image corresponding to the symbol selected at step S404, and displays the effect image on the display region 92 (see FIG. 8A).

102 Next, the main CPU 41 judges whether or not a “Win” effect has been read (step S406). Specifically, the main CPU 41 judges whether or not the effect image read at step S405 corresponds to the “Win” effect. Upon judging that the read-out image does not correspond to the “Win” effect (step S406: NO), the main CPU 41 displays the effect image of “Lose” (step S407). Specifically, the main CPU 41 reads out of the ROM 42, the effect image corresponding to the effect image of “Lose”, and displays the effect image on the display region 92 (see FIG. 8B). The main CPU 41 then executes a coin-payout process corresponding to a “Mini” payout, i.e., a Mini-payout process.

Next, the main CPU 41 changes a light emission pattern to one corresponding to the Mini-payout process (step S408). Specifically, the main CPU 41 changes the light emission pattern corresponding to the bonus game determined at step S401 to the light emission pattern corresponding to the Mini-payout process, by reading it from among light emission patterns stored in the ROM 42.

On the other hand, upon judging that the “Win” effect has been read (step S406: YES), the main CPU 41 displays a second effect selection image (step S409). Specifically, the main CPU 41 displays on the display region 92 a selection screen for determining a type of the jackpot bonus game, in a manner to make the symbol selected at step S404 identifiable.

Next, the main CPU 41 judges whether or not the predetermined symbol has been selected (step S410). Specifically, the main CPU 41 judges whether or not any of symbols other than the symbol selected at step S404 has been selected via the touch panel or the like. Upon judging that the predetermined symbol has not been selected (step S410: NO), the main CPU 41 controls the current step to return to the process at step S410.

On the other hand, upon judging that the predetermined symbol has been selected (step S410: YES), the main CPU 41 displays an effect image corresponding to the selected symbol (step S411). Specifically, the main CPU 41 sequentially reads out of the ROM 42 the effect image corresponding to the symbol selected at step S410, and displays the effect image on the display region 92.

107 Next, the main CPU 41 judges whether or not a “Win” effect has been read (step S412). Specifically, the main CPU 41 judges whether or not the effect image read at step S411 corresponds to the “Win” effect. Upon judging that the read-out image does not correspond to the “Win” effect (step S412: NO), the main CPU 41 displays the effect image of “Lose” (step S413). Specifically, the main CPU 41 reads out of the ROM 42 the effect image corresponding to the effect image of “Lose”, and displays the effect image on the display region 92 (see FIG. 9A), and executes a coin-payout process corresponding to a “Manor” payout.

Next, the main CPU 41 changes a light emission pattern to one corresponding to a Major-payout process (step S414). Specifically, the main CPU 41 changes the light emission pattern corresponding to the bonus game determined at step S401 to the light emission pattern corresponding to the Major-payout process, by reading it from among light emission patterns stored in the ROM 42.

On the other hand, upon judging that the “Win” effect has been read (step S412: YES), the main CPU 41 displays the effect image of “Win” (step S415). Specifically, the main CPU 41 reads out of the ROM 42 the effect image corresponding to the effect image of “Win”, and displays the effect image on the display region 92 (see FIG. 9B).

Next, the main CPU 41 changes a light emission pattern to one corresponding to a Mega-payout process (step S416). Specifically, the main CPU 41 changes the light emission pattern corresponding to the bonus game determined at step S401 to the light emission pattern corresponding to the Mega-payout process, by reading it from among light emission patterns stored in the ROM 42. When terminating the process at step S408, S414, or S416, the main CPU 41 terminates the jackpot bonus game execution process.

Next, a slot machine 100 according to a second embodiment will be described in detail with reference to the drawings. Here, the slot machine according to the second embodiment described below is a so-called hybrid type slot machine, which has a transparent liquid crystal panel allocated in front of a plurality of mechanical reels supported in a rotatable manner, and executes a game by displaying images of various types of symbols drawn on an outer peripheral surface of the mechanical reels through the transparent liquid crystal panel. The slot machine according to the second embodiment has an appearance, circuitry, and the like that are substantially the same as those of the slot machine 10 according to the first embodiment. Thus, a duplicated explanation is omitted here. In addition, the constituent elements corresponding to those of the slot machine 10 are designated by the same reference numerals and are explained.

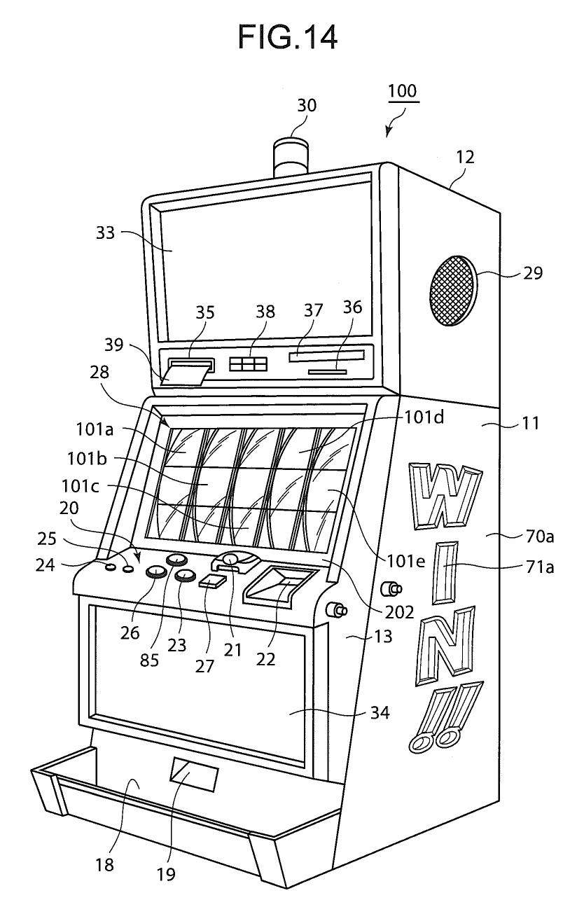

FIG. 14 is a view for schematically showing an appearance of the slot machine according to the second embodiment of the present invention. As shown in FIG. 14, the slot machine 100 is rotatably provided with five reels 101a to 101e. A symbol column made up of the symbols “main character” 121, “sub character” 122, “office building” 123, “gold bullion” 124, “car” 125, “stock certificate” 126, “jet” 127, and “villa” 128 is drawn on the respective one of the outer circumferential surfaces of the reels 101a to 101e.

A main liquid crystal panel 202 formed of a transparent liquid crystal panel, which is disposed at the main door, is provided in front of the respective reels 101a to 101e. The main liquid crystal panel 202 displays the symbol display region 28 with a visually recognizable rear surface so as to surround symbols displayed on the reels 101a to 101e in a stopped state, respectively. The symbols drawn on the reels 101a to 101e are visualized by rendering the symbol display region transparent.

As shown in FIG. 14, at a side wall of the slot machine 100, the melamine facing plate 70a formed with an opening in a predetermined shape is provided. Furthermore, in the slot machine 100, the light emitting device 75 is provided at a position corresponding to the opening formed in the side wall (see FIG. 3). In this case, the opening 71a formed in a letter shape of “WIN” is formed in the melamine facing plate 70a. In the case where the symbols rearranged in the symbol matrix SM form a predetermined combination, the light emitting device 75 is controlled to emit light in accordance with a light emission pattern at the time of execution of the free game or the jackpot bonus game, and thus, the opening 71a formed in the letter shape “WIN” emits light.

While the foregoing embodiments assumedly described that a light emission pattern is read out of the ROM 42 to control light emission of the light emitting in accordance with the read-out light emission pattern at the time of execution of the free game or the jackpot bonus game, in the case where the rearranged symbols form a predetermined combination, the present invention is not limitative thereto. It may be possible to structure the light emitting device 75 to emit light in either of two cases, which are randomly or selectively determined, i.e., one in accordance with a light emission pattern read out of the ROM 42, and the other regardless of this read-out light emission pattern.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

What is claimed is:

1. A slot machine, comprising:
a display device having a symbol display region for displaying plural types of symbols;
a casing;
a side wall making up part of the casing, formed with an opening in a predetermined shape;
a light emitting device provided inside the casing, at a position corresponding to the opening formed in the side wall;
a memory for storing a plurality of light emission patterns of the light emitting device; and
a controller for controlling the display device, the light emitting device, and the memory, the controller being programmed to:
(a) execute a basic game;
(b) rearrange the plural types of symbols in the symbol display region during the basic game;
(c) award a payout in accordance with a predetermined combination, in the case where the symbols displayed on the symbol display region are arranged in the predetermined combination; and
(d) read one of the light emission patterns stored in the memory to control the light emitting device to emit light in accordance with the read light emission pattern.

2. The slot machine according to claim 1, wherein:
the memory stores the light emission patterns of the light emitting device, in a manner to correspond to combinations of the plural types of symbols rearranged in the symbol display region; and
the controller, in the itemized (d), reads out of the memory, one of the light emission patterns which is corresponding to a combination of the plural types of symbols rearranged in the symbol display region, and controls the light emitting device to emit light in accordance with the light emission pattern read out of the memory.

3. The slot machine according to claim 2, wherein:
the controller, in the itemized (d), randomly or selectively executes a first process and a second process, the first process is for controlling the light emitting device to emit light in accordance with the light emission pattern read out of the memory, and the second process is for controlling the light emitting device to emit light regardless of the light emission pattern read out of the memory.

4. A slot machine, comprising:
a display device having a symbol display region for displaying a plural types of symbols;
a casing;
a side wall making up part of the casing, formed with an opening in a predetermined shape;
a light emitting device provided inside the casing, at a position corresponding to the opening formed in the side wall;
a memory for storing a plurality of light emission patterns of the light emitting device, in a manner to correspond to combinations of the plural types of symbols rearranged in the symbol display region; and
a controller for controlling the display device, the light emitting device, and the memory, the controller being programmed to:
(a) execute a basic game;
(b) rearrange the plural types of symbols in the symbol display region during the basic game;
(c) award a payout in accordance with a predetermined combination, in the case where the symbols displayed on the symbol display region are arranged in the predetermined combination; and
(d) read out of the memory, one of the light emission patterns which is corresponding to a combination of the plural types of symbols rearranged in the symbol display region, and controls the light emitting device to emit light in accordance with the light emission pattern read out of the memory.

5. The slot machine according to claim 4, wherein:
the controller, in the itemized (d), randomly or selectively executes a first process and a second process, the first process is for controlling the light emitting device to emit light in accordance with the light emission pattern read out of the memory, and the second process is for controlling the light emitting device to emit light regardless of the light emission pattern read out of the memory.

6. A slot machine, comprising:
a display device having a symbol display region for displaying a plural types of symbols;
a casing;
a side wall making up part of the casing, formed with an opening in a predetermined shape;
a light emitting device provided inside the casing, at a position corresponding to the opening formed in the side wall;
a memory for storing a plurality of light emission patterns of the light emitting device, in a manner to correspond to combinations of the plural types of symbols rearranged in the symbol display region; and
a controller for controlling the display device, the light emitting device, and the memory, the controller being programmed to:
(a) execute a basic game;
(b) rearrange the plural types of symbols in the symbol display region during the basic game;
(c) award a payout in accordance with a predetermined combination, in the case where the symbols displayed on the symbol display region are arranged in the predetermined combination; and
(d) read out of the memory, one of the light emission patterns which is corresponding to a combination of the plural types of symbols rearranged in the symbol display region, and randomly or selectively execute a first process and a second process, the first process is for controlling the light emitting device to emit light in accordance with the light emission pattern read out of the memory, and the second process is for controlling the light emitting device to emit light regardless of the light emission pattern read out of the memory.
